(19) United States
(12) Patent Application Publication
(10) Pub. No.: US 2025/0026675 A1
(43) Pub. Date: Jan. 23, 2025

(54) HIGH PRESSURE DRAW FURNACE AND METHODS OF PRODUCING OPTICAL FIBERS

(71) Applicant: CORNING INCORPORATED, CORNING, NY (US)

(72) Inventors: Nikolaos Pantelis Kladias, Horseheads, NY (US); Ming-Jun Li, Horseheads, NY (US); Bruce Warren Reding, Corning, NY (US); Pushkar Tandon, Painted Post, NY (US); Kevin Lee Wasson, Elmira, NY (US)

(21) Appl. No.: 18/769,986

(22) Filed: Jul. 11, 2024

Related U.S. Application Data
(60) Provisional application No. 63/528,094, filed on Jul. 21, 2023.

(51) Int. Cl. C03B 37/029

(52) U.S. Cl. CPC C03B 37/029; C03B 2205/10; C03B 2205/80; C03B 2205/82

(57) ABSTRACT

A method of forming an optical fiber, the method including heating a forming region of the optical fiber preform within a pressure device while exposing the forming region to a total pressure of about 500 atm or greater, directing the optical fiber preform in a downstream direction along a process pathway to form the optical fiber, and traversing the optical fiber through an aperture of a nozzle to maintain the total pressure of about 500 atm or greater within the pressure device.

This application claims the benefit of priority under 35 U.S.C § 120 of U.S. Provisional Application Ser. No. 63/528,094 filed on Jul. 21, 2023, the content of which is relied upon and incorporated herein by reference in its entirety.

### FIELD

The present disclosure is directed to a high pressure draw furnace and methods of producing optical fibers with such a draw furnace and, more particularly, to the production of optical fiber having reduced Rayleigh scattering.

### BACKGROUND

Optical fiber is increasingly being used for a variety of applications, including but not limited to broadband voice, video, and data transmission. As bandwidth demands increase, optical fiber is migrating deeper into communication networks including fiber-to-the-premises applications, such as FTTx, 5G, and the like.

However, traditional optical fiber inherently induces optical loss in optical signals that propagate within the optical fiber. This optical loss produces signal degradation that can affect network performance. One source of optical loss is the presence of structural voids within the optical fiber that cause Rayleigh scattering and overall signal attenuation.

Consequently, there exists an unresolved need for optical fiber draw production systems and methods of optical fiber production that reduce the presence of structural voids.

### SUMMARY

The present disclosure is directed to optical fiber draw production systems, pressure devices, and methods of fabrication of optical fiber that apply pressure to the optical fiber within the draw furnace and at or near the point of optical fiber formation to reduce the presence of structural voids in the formed optical fiber.

In one embodiment, a method of forming an optical fiber comprises heating a forming region of the optical fiber preform within a pressure device while exposing the forming region to a total pressure of about 500 atm or greater, directing the optical fiber preform in a downstream direction along a process pathway to form the optical fiber, and traversing the optical fiber through an aperture of a nozzle to maintain the total pressure of about 500 atm or greater within the pressure device.

In another embodiment, a fiber draw furnace comprises a pressure device, a heater, and a nozzle. The pressure device comprising an inner cavity configured to receive an optical fiber preform. The heater being configured to heat at least a forming region of an optical fiber preform to draw the optical fiber preform into an optical fiber, and the heater being configured to heat the forming region while exposing the optical fiber preform to a total pressure of about 500 atm or greater within the inner cavity. The nozzle being disposed downstream of the inner cavity and configured to maintain the total pressure of about 500 atm or greater within the inner cavity while the optical fiber traverses through an aperture in the nozzle.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 schematically illustrates an optical fiber draw furnace having a pressure device according to one or more embodiments described and illustrated herein;

FIG. 2 schematically illustrates a partial view of the optical fiber draw furnace of FIG. 1 according to one or more embodiments described and illustrated herein;

FIG. 3A schematically illustrates the pressure device of FIGS. 1 and 2 according to one or more embodiments described and illustrated herein;

FIG. 3B schematically illustrates a partial view of the pressure device of FIG. 3A according to one or more embodiments described and illustrated herein;

FIG. 3C schematically illustrates an embodiment of a pressure device according to one or more embodiments described and illustrated herein;

FIG. 3D schematically illustrates an optical fiber draw furnace including the pressure device of FIG. 3C according to one or more embodiments described and illustrated herein;

FIG. 4 is a plot of tin viscosity vs. temperature according to one or more embodiments described and illustrated herein;

FIG. 5 schematically illustrates a cross-sectional view of an optical fiber produced according to one or more embodiments described and illustrated herein;

FIG. 6 schematically illustrates a cross-sectional view of a nozzle with an optical fiber disposed therethrough according to one or more embodiments described and illustrated herein;

FIG. 7A schematically illustrates an optical fiber draw furnace having a pressure device with an off-center fiber according to one or more embodiments described and illustrated herein;

FIG. 7B schematically illustrates a cross-sectional view of a nozzle with an offset optical fiber disposed therethrough;

FIG. 7C shows the gas pressure within the nozzle of FIG. 7B;

FIG. 8 is a plot of centration force vs. taper angle according to one or more embodiments described and illustrated herein;

FIG. 9 is a plot of centration force vs. gas pressure according to one or more embodiments described and illustrated herein;

FIG. 10 is a plot of molten tin volume flow rate vs. gas pressure according to one or more embodiments described and illustrated herein;

FIG. 11 schematically illustrates another embodiment of a pressure device according to one or more embodiments described and illustrated herein;

FIG. 12 schematically illustrates another embodiment of a nozzle along with the gas pressure within according to one or more embodiments described and illustrated herein;

FIG. 13 is a plot of centration force vs. gas pressure according to one or more embodiments described and illustrated herein;

FIG. 14 is a plot of molten tin volume flow rate vs. gas pressure according to one or more embodiments described and illustrated herein; and

FIG. 15 schematically illustrates another embodiment of a nozzle along with the gas pressure within according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

The present disclosure is directed to optical fiber draw production systems, pressure devices, and methods of fabrication of optical fiber that apply pressure to an optical fiber preform within a draw furnace and at or near the point of optical fiber formation to reduce the presence of structural voids in the formed optical fiber. Structural voids within the optical fiber cause undesirable Rayleigh scattering and overall signal attenuation. In the optical fiber draw process, an optical fiber is formed from bulk glass (e.g. a preform) by heating the bulk glass to softening and drawing (pulling) an optical fiber from the softened glass through the action of gravity and application of a draw tension. One strategy for reducing the presence of structural voids in glass is to apply pressure to the glass to rearrange or densify the glass structure to remove or minimize structural voids.

Unless otherwise specified, the temperature is expressed herein in units of° C. (degrees Celsius).

The term “process pathway” refers to the pathway traversed by an optical fiber in an optical fiber draw process.

The relative position of one process unit relative to another process unit along the process pathway is described herein as upstream or downstream. The upstream direction of the process pathway is the direction toward the preform and the downstream direction of the process pathway is the direction toward the winding stage. Positions or processing units upstream from a reference position or processing unit are closer, along the process pathway, to the preform than the reference position or processing unit. A process unit located at a position closer to the draw furnace along the process pathway is said to be upstream of a process unit located at a position further away from the draw furnace along the process pathway. The draw furnace is upstream from all other process units and the take-up spool (or winding stage or other terminal unit) is downstream of all other process units.

The term “optical fiber” refers to a glass waveguide. The glass waveguide includes a glass core and a glass cladding. The glass cladding surrounds and is directly adjacent to the glass core. The glass cladding may include two or more concentric glass regions that differ in refractive index. The refractive index of the glass core is greater than the refractive index of the glass cladding (or the average refractive index of the glass cladding when the glass cladding includes multiple concentric regions) at a wavelength of 1550 nm.

Embodiments of the present disclosure apply high pressure (e.g., 500 atm or greater) to a preform in an optical fiber draw process during the draw of the preform to an optical fiber. More particularly, embodiments employ a pressure device that applies pressure to the preform without the preform or drawn optical fiber physically contacting any component of the pressure device or other components of the optical fiber draw furnace.

Pressure is preferably applied to the optical fiber preform by the pressure device while the preform is at an elevated temperature. In some embodiments, pressure is applied to the forming region of the preform. Embodiments further provide centering forces on the optical fiber to ensure no physical contact between it and structures of the optical fiber draw production system.

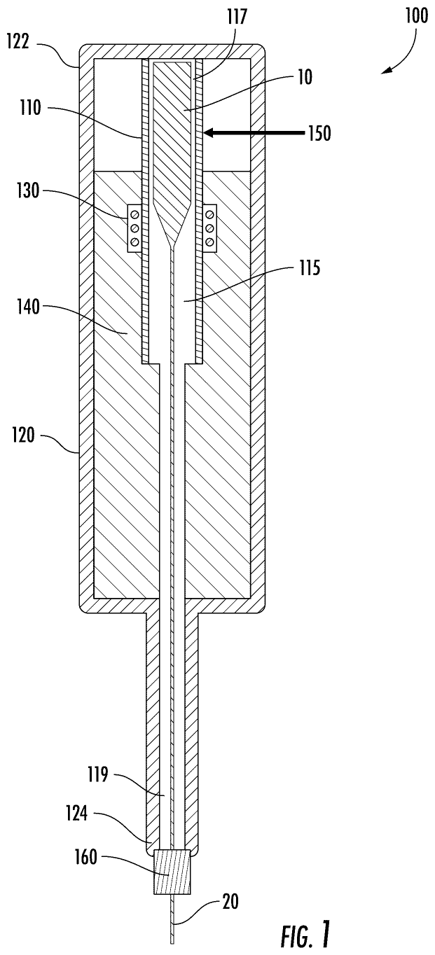

Various embodiments of optical fiber draw production systems, pressure devices, and methods for forming optical fiber that apply pressure to an optical fiber during fiber formation to reduce or eliminate structural voids are described in detail below. Referring now to FIG. 1, an exemplary optical fiber draw furnace 100 is shown. Draw furnace 100 comprises a sleeve 110, such as a susceptor sleeve, and a pressure device 120 configured to receive an optical fiber preform 10. Sleeve 110 may be disposed within pressure device 120. As discussed further below, draw furnace 100 draws preform 10 into an optical fiber 20. In the embodiments disclosed herein, draw furnace 100 draws preform 10 into optical fiber 20 under a high pressure to reduce any Rayleigh scattering and attenuation in the drawn fiber.

Preform 10 may be composed of any well-known glass or other material and may be doped suitable for the manufacture of optical fibers. In some embodiments, preform 10 includes a core and a cladding. As discussed further below, preform 10 is heated and consumed during the draw process. A downfeed handle (not shown) may be attached to preform 10 to lower the preform within pressure device 120 as the preform is consumed.

Sleeve 110 forms a tubular member comprising an inner cavity 115 through which preform 10 may be moveably disposed. An upper heater 130 is disposed adjacent to sleeve 110 to create a hot zone within draw furnace 100. In embodiments, upper heater 130 is an induction coil. The heat of the hot zone decreases the viscosity of preform 10 to draw preform 50 into optical fiber 20. Upper heater 130 and sleeve 110 may be encased by insulation 140 comprising a refractory material such as, for example, silicon, aluminum, magnesium, calcium, boron, chromium, zirconium, or mixtures thereof. As shown in FIG. 1, inner cavity 115 extends through both sleeve 110 and insulation 140 from a first end 117 of the cavity to a second end 119 of the cavity. In some embodiments, a liner (not shown) may be disposed between inner cavity 115 and insulation 140.

As also shown in FIG. 1, pressure device 120 comprises a first end 122 and a second end 124 such that first end 122 is proximate to preform 10 and second end 124 is proximate to the drawn optical fiber 20. It is noted that first end 122 of pressure device 120 is proximate to first end 117 of inner cavity 115 and that second end 124 of pressure device 120 is proximate to second end 119 of inner cavity 115. Furthermore, inner cavity 115 extends for the length of pressure device 120 from first end 122 to second end 124. A nozzle 160 is disposed at second end 124 of pressure device 120. With the exception of a very thin aperture in nozzle 160, as discussed further below, pressure device 120 is sealed at first end 122 and at second end 124 so that inner cavity 115 of sleeve 110 is also sealed. It is noted that optical fiber 20 is positioned within the very thin aperture of nozzle 160, which allows pressure device 120 to be sealed (or effectively sealed). Furthermore, a gas inlet 150 is configured to inject process gas into inner cavity 115 during the draw process. The process gas may comprise helium, argon, nitrogen, air, oxygen, krypton, xenon, or a combination thereof. The combination of the sealing of pressure device 120 and the injection of the process gas into inner cavity 115 allows inner cavity 115 to be pressurized to a relatively high pressure. In embodiments disclosed herein, inner cavity 115 is pressurized to a relatively high pressure before optical fiber 20 is drawn from preform 10.

The flow rate of the process gas into inner cavity 115 is about 100 g/min or less, or about 75 g/min or less, or about 50 g/min or less. In some embodiments, the temperature of the process gas injected into inner cavity 115 is between about 10° C. and about 1100° C., or between about 15° C. and about 500° C., or between about 20° C. and about 200° C., or at room temperature (i.e., about 25°° C.). It is also contemplated that inner walls of inner cavity 115 are at an elevated temperature, such as between about 300° C. and about 600° C. The elevated temperature of the inner walls may assist with minimizing any cooling of preform 10 and/or optical fiber 20 within pressure device 120.

In embodiments, inner cavity 115 is pressurized to a relatively high total gas pressure and preform 10 is heated by upper heater 130 and consumed into optical fiber 20 while exposed to this relatively high pressure within pressure device 120. Therefore, the glass of preform 10 is compressed to a higher density under the relatively high pressure before it is drawn into optical fiber 20. More specifically, the relatively high pressure within inner cavity 115, as disclosed herein, compresses the glass of preform 10 before it is drawn into an optical fiber. This compression increases the density of preform 10 before it is drawn into an optical fiber, which reduces the size of any voids in preform 10. Without being bound by theory, it is believed that the hydrostatic pressure applied on the voids from the relatively high pressure overcomes any pressure forces within the voids, thereby causing the voids to collapse. The collapse of voids in preform 10 translates to a reduction of void size in the drawn optical fiber 20, which reduces Rayleigh scattering and attenuation in the drawn optical fiber 20.

Inner cavity 115 is pressurized to a relatively high total gas pressure of about 500 atm or greater, or about 750 atm or greater, or about 1,000 atm or greater, or about 1,250 atm or greater, or about 1,500 atm or greater, or about 1,750 atm or greater, or about 2,000 atm or greater, or about 5,000 atm or greater, or about 10,000 atm or greater, or about 20,000 atm or greater, or about 30,000 atm or greater, or about 40,000 atm or greater, or about 50,000 or greater, or about 60,000 atm or greater, or about 70,000 atm or greater, or about 80,000 atm or greater. Additionally or alternatively, inner cavity 115 is pressurized to a total gas pressure of about 80,000 atm or less, or about 70,000 atm or less, or about 60,000 atm or less, or about 50,000 atm or less, or about 40,000 atm or less, or about 30,000 atm or less, or about 20,000 atm or less, or about 10,000 atm or less, or about 5,000 atm or less, or about 2,000 atm or less, or about 1,750 atm or less, or about 1,500 atm or less, or about 1,250 atm or less, or about 1,000 atm or less, or about 750 atm or less, or about 500 atm or less. In embodiments, inner cavity 115 is pressurized to a total gas pressure from about 500 atm to about 80,000 atm, or about 500 atm to about 50,000 atm, or about 500 atm to about 10,000atm, or about 500 atm to about 5,000 atm, or about 500 atm to about 2,000 atm, or about 750atm to about 1,750 atm, or about 1,000 atm to about 1,500 atm, or about 1,250 atm to about 2,000 atm, or about 1,500 atm to about 2,000 atm, or about 1,750 atm to about 2,000 atm. As noted above, this total gas pressure within inner cavity 115 compresses preform 10 within inner cavity 115. The total gas pressure within inner cavity 115 may be uniform and constant throughout the length of the cavity. Therefore, the pressure within inner cavity 115 at a first end 117 of inner cavity 115 is the same (or approximately the same) as the pressure at a second end 119 of inner cavity 115.

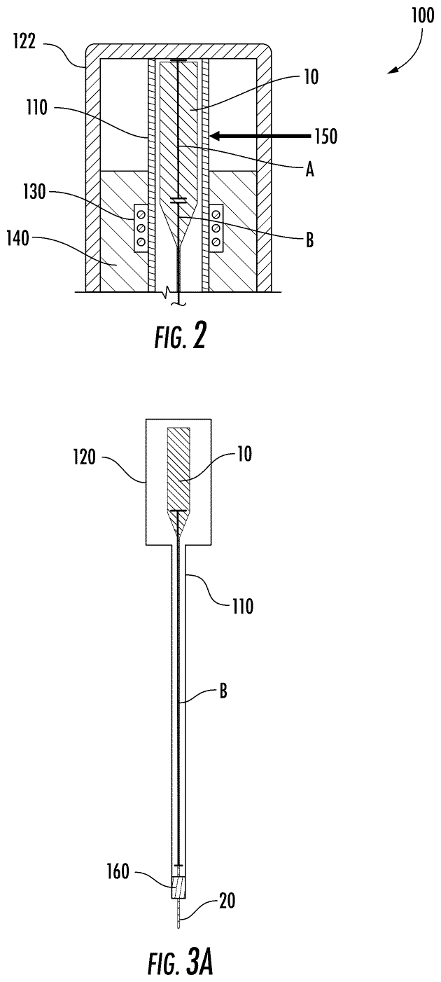

FIG. 2 shows an enlarged image of a portion of draw furnace 100 of the embodiment of FIG. 1. As discussed above, upper heater 130 creates a hot zone within draw furnace 100 to lower the viscosity of the preform to draw the preform into optical fiber 20. At region A (above the neckdown region of the preform), preform 10 is heated to a temperature below the softening point of the glass. At region B, preform 10 is heated to a temperature at or above the softening point of the glass to draw the preform into an optical fiber. In embodiments, region B of preform 10 is heated to a temperature from about 1570° C. to about 2100°° C., or about 1585° C. to about 2075° C., or about 1600° C. to about 2050° C., or about 1625° C. to about 2000° C., or about 1650°° C. to about 1975° C., or about 1670° C. to about 1975° C., or about 1675° C. to about 1950° C., or about 1700° C. to about 1925° C., or about 1725° C. to about 1900°° C., or about 1750° C. to about 1875° C., or about 1670° C. to about 2100° C. Therefore, the temperature of preform 10 at region A is below the temperature of perform 10 at region B.

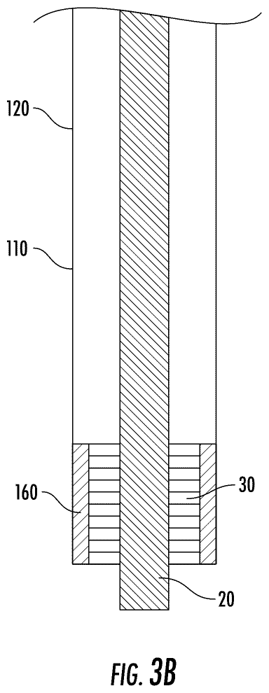

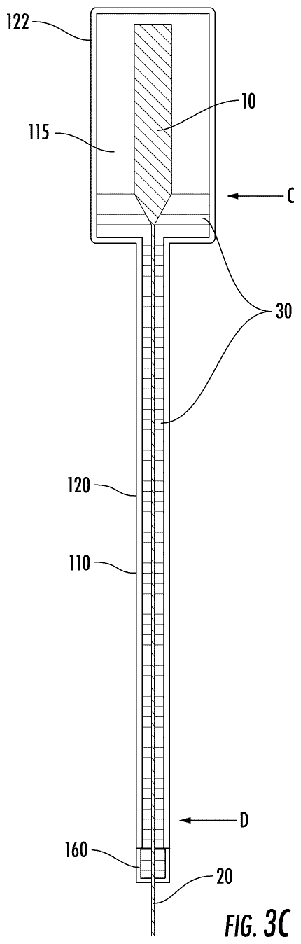

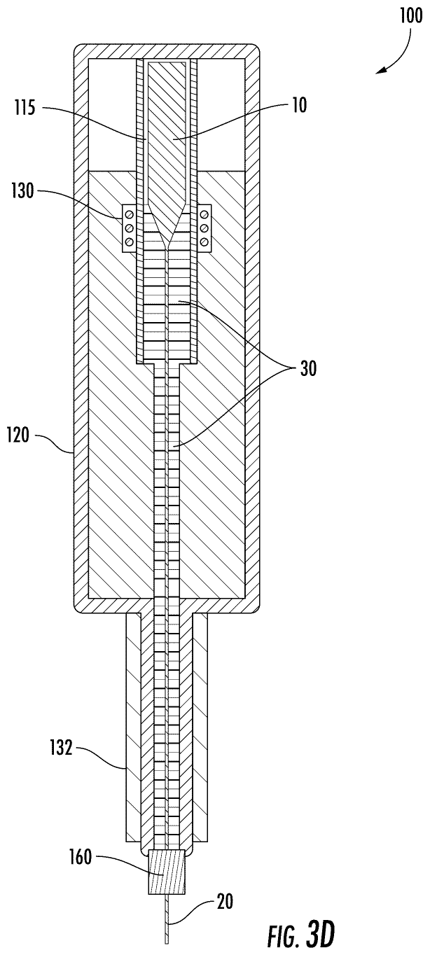

Region B of preform 10 comprises a forming region of preform 10, which includes the portion of preform 10 that extends from the end of region A to optical fiber 20. As shown in FIG. 2, Region B comprises the neckdown region of preform 10. The transition point between region B and optical fiber 20 is the point at which the diameter of the preform reaches the diameter of optical fiber 20 (e.g., 125 microns). Once the diameter of preform 10 is the diameter of optical fiber 20, region B of preform 10 has terminated and transitioned into optical fiber 20. Therefore, throughout the entirety of region B, preform 10 has a larger diameter than the diameter of optical fiber 20. In some embodiments, the diameter of optical fiber 20 is 125 microns, in which case region B terminates at the point at which the diameter of the preform has reached 125 microns. In other embodiments, the diameter of optical fiber 20 is 150 microns, in which case region B terminates at the point at which the diameter of the preform has reached 150 microns. It is noted that region B may terminate closer to nozzle 160 than depicted in FIG. 3A (or within nozzle 160 or downstream of nozzle 160). In some embodiments, region B terminates upstream of nozzle 160. Furthermore, as shown in FIGS. 2 and 3A, region B is downstream of region A. It is also noted that the temperature of the drawn optical fiber 20 within pressure device 120 is at the same temperature (or approximately the same temperature) as the temperature of preform 10 at region B.

As discussed above, inner cavity 115 is pressurized to a relatively high gas pressure of, for example, about 500 atm or greater. Therefore, the glass of preform 10 is subject to the compression forces caused by the relatively high gas pressure within inner cavity 115. As is known in the art, when particles are compressed, the density of that component increases. Therefore, as the glass particles within preform 10 are compressed by the relatively high gas pressure, the glass particles of preform 10 densify. The densification of preform 10 is further amplified by the heating of preform 10 within region B, which lowers the viscosity of the glass so that it is more susceptible to the compression forces. As noted above, region B of preform 10 is heated to a higher temperature than region A so that the glass obtains a higher density in region B than in region A. The increased density in region B of preform 10 is maintained in the optical fiber 20 drawn directly from region B. In particular, the increased density is maintained in the drawn optical fiber 20 because the fiber is also subject to the same compression forces within inner cavity 115. Therefore, both region B of preform 10 and the drawn optical fiber 20 have a relatively higher density.

In some embodiments, preform 10 may be pre-densified before the draw process (for example, preform 10 may be densified before being disposed within pressure device 120). In these embodiments, when preform 10 is then subject to the high gas pressure within pressure device 120, the increased density of preform 10 is maintained due to the relatively high gas pressure within inner cavity 115. More specifically, the relatively high gas pressure within inner cavity 115 prevents the densified preform 10 from reverting back to its state before such densification. In these embodiments, both region A and region B of preform 10 have the relatively higher density. Therefore, in these embodiments, the drawn optical fiber 20 also has the relatively higher density.

As discussed above, the relatively higher density causes voids to collapse in the glass. It is noted that the voids remain collapsed and do not reopen as long as the glass is subject to the relatively high gas pressure until the glass is cooled. Therefore, in the embodiments disclosed herein, the length of inner cavity 115 is at the relatively high gas pressure so that the drawn optical fiber is exposed to such relatively high gas pressure until the optical fiber is cooled. This allows the voids in the drawn optical fiber to remain collapsed.

As noted above, the drawn optical fiber 20 may have a higher density than in traditional draw processes. In embodiments, the density of the drawn optical fiber 20 is about 2.200 g/cm³ or greater, or about 2.220 g/cm³ or greater, or about 2.225 g/cm³ or greater, or about 2.230 g/cm³ or greater, or about 2.250 g/cm³ or greater, or about 2.275 g/cm³ or greater, or about 2.300 g/cm³ or greater, or about 2.325 g/cm³ or greater, or about 2.350 g/cm³ or greater, or about 2.375 g/cm³ or greater, or about 2.400 g/cm³ or greater, or about 2.425 g/cm³ or greater, or about 2.450 g/cm³ or greater, or about 2.475 g/cm³ or greater, or about 2.500 g/cm³ or greater, or about 2.525 g/cm³ or greater, or about 2.550 g/cm³ or greater, or about 2.575 g/cm³ or greater, or about 2.600 g/cm³ or greater, or about 2.625 g/cm³ or greater, or about 2.650 g/cm³ or greater, or about 2.675 g/cm³ or greater, or about 2.700 g/cm³ or greater. Additionally or alternatively, the density of the drawn optical fiber is about 2.700 g/cm³ or less, or about 2.675 g/cm³ or less, or about 2.650 g/cm³ or less, or about 2.625 g/cm³ or less, or about 2.600 g/cm³ or less, or about 2.575 g/cm³ or less, or about 2.550 g/cm³ or less, or about 2.525 g/cm³ or less, or about 2.500 g/cm³ or less, or about 2.475 g/cm³ or less, or about 2.450 g/cm³ or less, or about 2.425 g/cm³ or less, or about 2.400 g/cm³ or less, or about 2.375 g/cm³ or less, or about 2.350 g/cm³ or less, or about 2.325 g/cm³ or less, or about 2.300 g/cm³ or less, or about 2.275 g/cm³ or less, or about 2.250 g/cm³ or less, or about 2.230 g/cm³ or less, or about 2.225 g/cm³ or less, or about 2.220 g/cm³ or less. In embodiments, the density is from about 2.200 g/cm³ to about 2.300 g/cm^{3,} or about 2.220 g/cm³ to about 2.700 g/cm^{3,} or about 2.250 g/cm³ to about 2.600 g/cm^{3,} or about 2.275 g/cm³ to about 2.500 g/cm³.

As discussed further below, optical fiber 20 exits pressure device 120 through nozzle 160. As discussed further below, nozzle 160 advantageously helps to maintain the relatively high gas pressure within inner cavity 115 of pressure device 120. In particular, nozzle 160 comprises an aperture through which optical fiber 20 extends. The aperture has a small diameter to maintain the desired pressure within inner cavity 115. Furthermore, the aperture is structured so that optical fiber 20 is centered within the narrow opening, to prevent optical fiber 20 from contacting an inner wall of nozzle 60.

During the draw process, the draw speed of optical fiber 20 is about 5 m/s or greater, or about 20 m/s or greater, or about 40 m/s or greater. However, embodiments of the present disclosure are not limited by any particular draw speed.

FIG. 3A shows pressure device 120 of FIG. 1A (with nozzle 160 attached thereto) separate from the remaining components of draw furnace 100. FIG. 3B shows another embodiment of pressure device 120 in which a molten metal 30 is disposed within nozzle 160. In particular, FIG. 3B shows a partial cross-sectional view of pressure device 120 and of nozzle 160 with optical fiber 20 disposed therein. Molten metal 30 may fill up an entire interior space of nozzle 160 or just a portion thereof. In some embodiments, molten metal 30 is at a bottom portion of nozzle 160. Molten metal 30 helps to seal pressure device 120 and inner cavity 115 while allowing optical fiber 20 to exit through the aperture in nozzle 160. In embodiments, molten metal 30 comprises a metal material such that the melting point of the metal material is less than the softening point of preform 10. Therefore, molten metal 30 is in a liquified state within nozzle 160. Exemplary examples of molten metal 30 include, for example, tin (Sn), gold (Au), copper (Cu), aluminum (Al), and combinations thereof.

FIG. 3C shows another embodiment of pressure device 120 in which molten metal 30 is disposed within nozzle 160 and within inner cavity 115. In particular, FIG. 3C shows a cross-sectional view of pressure device 120 and of nozzle 160 with optical fiber 20 disposed therein. In the embodiment of FIG. 3C, molten metal 30 extends all the way from nozzle 160 to the neckdown region of preform 10. However, molten metal 30 should, preferably, not extend within region A of preform 10 so that the glass injected into inner cavity 115 can reach the desired relatively high pressure, as discussed above. FIG. 3D shows pressure device 120 of the embodiment of FIG. 3C in draw furnace 100. In this embodiment, draw furnace 100 further comprises a lower heater 132 to heat and melt molten metal 30. Lower heat 132 may be configured to maintain molten metal 30 in the liquefied state. In embodiments, lower heater 132 is an induction coil.

The relatively high gas pressure within inner cavity 115 applies a downward pressure on molten metal 30, so that molten metal 30 is also pressurized to a relatively high pressure state. Therefore, the glass of region B of preform and the glass of optical fiber 20 are subject to the compression forces of molten metal 30 as the fiber is drawn and passes through the molten metal. The pressurized molten metal 30 may be at the same relatively high pressures as disclosed above (e.g., about 500 atm or greater). However, the pressure applied by molten metal 30 may be a liquid pressure (as opposed to a gas pressure). For example, molten metal 30 may comprise a liquid pressure of about 500 atm or greater (or any of the pressures disclosed above with reference to the total gas pressure of inner cavity 115). And the pressurized molten metal 30 helps to maintain the voids in optical fiber 20 in the collapsed state so that the voids do not reopen as the fiber is drawn.

In embodiments in which molten metal 30 extends to the neckdown region of preform 10 (such that molten metal 30 surrounds the neckdown region (e.g., region B)), molten metal 30 advantageously isolates this region of preform 10 from any turbulent gas within inner cavity 115. As in known in the art, process gas is subject to flow instabilities as it flows within a draw furnace during a drawing process. These flow instabilities result in an uneven and irregular diameter in the drawn optical fiber. Unsteady convection, due to density stratification of the gas within the draw furnace and due to irregular flow of the process gas, causes such flow instabilities. For example, the flow of the process gas may form recirculations of gas in the draw furnace. These flow instabilities are manifested as temperature variations, pressure variations, and mass flow variations that are translated to the neckdown region of the preform, which ultimately cause fluctuations in the diameter of the drawn optical fiber. Molten metal 30 provides a barrier between any flow instabilities in inner cavity 115 and the neckdown region of preform 10. Therefore, molten metal 30 advantageously protects the drawn optical fiber from diameter fluctuations.

With reference again to FIG. 3C, a portion of molten metal 30 at region C, which is in proximity to the neckdown region (e.g., region B) of preform 10, is at a temperature that is equal to (or approximately equal to) the temperature of preform 10 at the neckdown region. It is noted that pressure device 120 must be at a sufficiently high temperature in this area to melt and draw preform 10, which also causes molten metal 30 to be at this high temperature. In embodiments, the temperature of molten metal 30 at region C is about 1570° C. to about 2100°° C., or about 1585° C. to about 2075°° C., or about 1600°° C. to about 2050° C., or about 1625° C. to about 2000° C., or about 1650° C. to about 1975° C., or about 1670° C. to about 1975° C., or about 1675° C. to about 1950° C., or about 1700° C. to about 1925° C., or about 1725°° C. to about 1900°° C., or about 1750°° C. to about 1875° C., or about 1670° C. to about 2100° C. Furthermore, a portion of molten metal 30 at region D, which is in proximity to nozzle 160, is at a lower temperature than the temperature of molten metal 30 at region C. In embodiments, the temperature of molten metal 30 at region D is about 1670° C. or less, or about 1600° C. or less, or about 1500° C. or less, or about 1400° C. or less, or about 1200° C. or less, or about 1000° C. or less, or about 700°° C. or less, or about 500° C. or less, or about 400° C. or less, or about 300° C. or less, or about 250° C. or less, or about 240° C. or less. Additionally or alternatively, the temperature of molten metal 30 at region D is about 240° C. or greater, or about 250° C. or greater, or about 300° C. or greater, or about 400° C. or greater, or about 500° C. or greater, or about 700° C. or greater, or about 1000° C. or greater, or in a range from about 240°° C. to about 1670° C., or about 250° C. to about 1600° C., or about 300° C. to about 1500° C., or about 400°° C. to about 1400°° C., or about 500° C. to about 1200°° C., or about 700° C. to about 1000° C. Furthermore, in embodiments, a gradient of temperature exists between regions C and D. The disclosed temperatures at region D allow the viscosity of molten metal 30 to increase near nozzle 160. It is known that as the temperature of a molten metal decreases, the viscosity of that molten metal increases so that molecular interchange within the metal decreases. Therefore, molten metal 30 at region D is relatively thicker and is less fluid than at region C. Stated another way, molten metal 30 at region D has a tackier consistency than at region C. The relatively thicker molten metal 30 at region D helps to seal the aperture within nozzle 160 to maintain the desired pressure within inner cavity 115. As shown in FIGS. 1, 3A, 3C, and 3D, inner cavity 115 has a length sufficient for molten metal 30 to transition from the high temperatures required at region C to the lower temperatures required at region D.

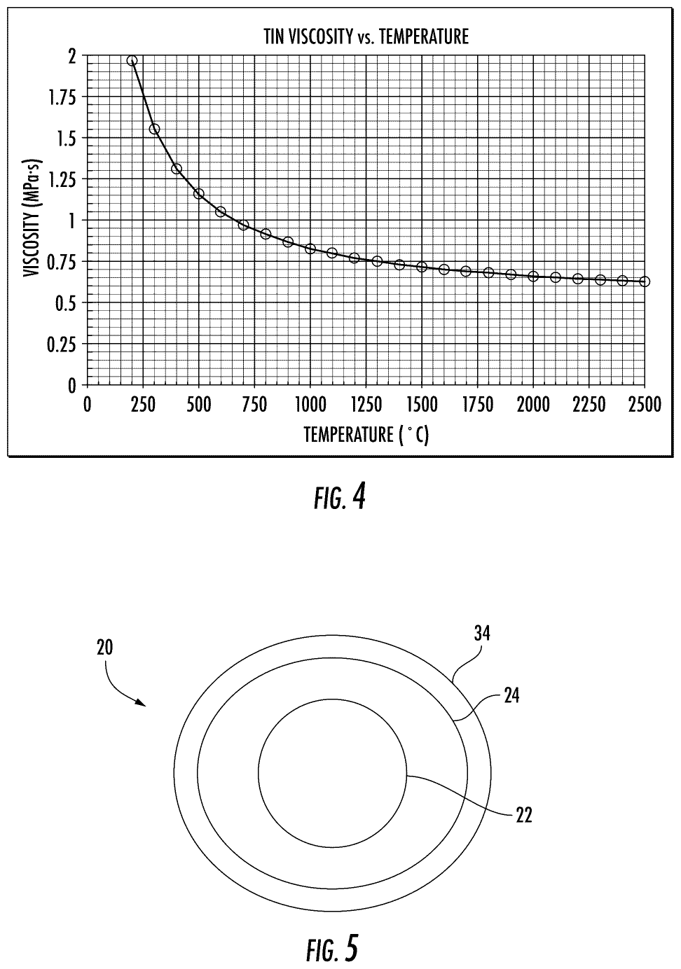

FIG. 4 shows the relationship between temperature and dynamic viscosity of molten tin (in units of MPa·s), as an exemplary molten metal 30. As shown in FIG. 4, as the temperature of the molten tin increases, the viscosity of the molten tin decreases, thus creating a more fluid-like consistency. Conversely, as the temperature of the molten tin decreases, the viscosity of the molten tin increases, thus creating a more tacky-like consistency.

In embodiments, molten metal 30 at region C has a viscosity from about 0.70 MPa·s to about 0.80 MPa·s, or about 0.72 MPa·s to about 0.78 MPa·s, or about 0.74 MPa·s to about 0.76 MPa·s, or about 0.75 MPa·s to about 0.77 MPa·s. In embodiments, molten metal 30 at region D has a viscosity from about 0.75 MPa·s to about 1.75 MPa·s, or about 0.80 MPa·s to about 1.70 MPa·s, or about 0.85 MPa·s to about 1.65 MPa·s, or about 0.90 MPa·s to about 1.60 MPa·s, or about 0.95 MPa·s to about 1.55 MPa·s, or about 1.00 MPa·s to about 1.50 MPa·s, or about 1.05 MPa·s to about 1.45 MPa·s, or about 1.10 MPa·s to about 1.40 MPa·s, or about 1.15 MPa·s to about 1.35 MPa·s, or about 1.20 MPa·s to about 1.30 MPa·s, or about 1.25 MPa·s to about 1.30 MPa·s. As discussed above, in embodiments, molten metal 30 has a higher viscosity at region D than at region C. Furthermore, molten metal 30 at regions C and D has a density from about 6500 Kg/m³ to about 8000 Kg/m³, or about 6700 Kg/m³ to about 7800 Kg/m³, or about 6900 Kg/m³ to about 7600 Kg/m³, or about 7000 Kg/m³ to about 7500 Kg/m³, or about 7100 Kg/m³ to about 7400 Kg/m³. In embodiments, the density of molten metal 30 at region C is the same as the density of molten metal 30 at region D. In other embodiments, the density of molten metal 30 at region C is different from the density of molten metal at region D.

In the embodiments disclosed herein that utilize molten metal 30, optical fiber 20 is surrounded by molten metal 30 as optical fiber 20 moves downward within inner cavity 115 and/or nozzle 160. Therefore, molten metal 30 forms an outer coating on optical fiber 20 once the fiber exits nozzle 160. The outer coating is radially outward of any outer cladding glass within optical fiber 20. FIG. 5 shows an exemplary embodiment of optical fiber 20, after exiting nozzle 160, that comprises a glass core 22, a glass cladding 24, and a metal coating 34. As shown in FIG. 5, glass cladding 24 radially surrounds glass core 22, and metal coating 34 radially surrounds glass cladding 24. In embodiments, the thickness of metal coating 34 is from about 5 microns to about 15 microns, or about 7 microns to about 12microns, or about 8 microns to about 10 microns. Optical fiber 20 can be further processed and stored with metal coating 34 thereon. For example, one or more polymeric layers may be disposed on metal coating 34 in downstream processing of optical fiber 20. Alternatively, metal coating 34 can be removed from optical fiber 20 by, for example, heat application before any further processing or storing of optical fiber 20.

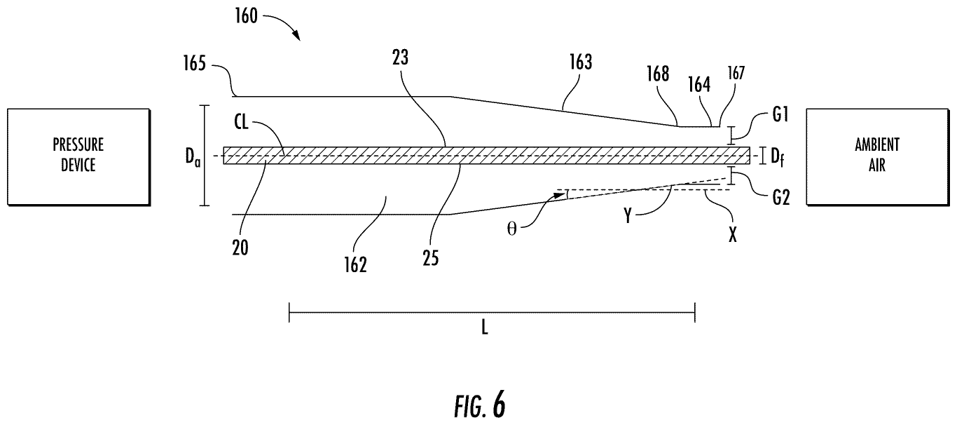

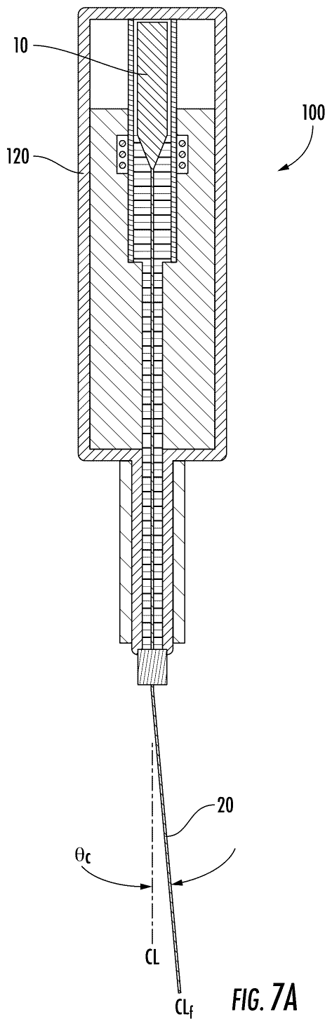

A cross-section of nozzle 160 with an optical fiber 20 positioned therein is depicted in FIG. 6. In particular, FIG. 6 shows optical fiber 20 disposed within aperture 162 of nozzle 160. It is noted that although FIG. 6 does not include molten metal 30 within nozzle 160, as discussed above, molten metal 30 may fill the entire interior of nozzle 160 or a portion thereof. It is also noted that the components of FIG. 6 are not drawn to scale. Aperture 162 extends through an entire length of nozzle 160, thus forming an opening from a first end 165 to a second end 167 of nozzle 160. Nozzle 160 also comprises at least a straight cylindrical member 164 and a tapered member 163, such that straight cylindrical member 164 is downstream of tapered member 163. As shown in FIG. 6, straight cylindrical member 164 extends from a transition region 168 to second end 167. The outer and inner diameters of nozzle 160 taper radially inward toward second end 167 within tapered member 163. It is also contemplated that just the inner diameter of nozzle 160 tapers radially inward toward second end 167 within tapered member 163 while the outer diameter does not taper inward.

An angle θ is formed between the inner wall of cylindrical member 164 and the inner wall of tapered member 163. More specifically, angle θ is formed between plane X of cylindrical member 164 and plane Y of tapered member 163 such that plane X extends along an inner profile of cylindrical member 164 and that plane Y extends along an inner profile of tapered member 163. Angle θ represents the taper angle of tapered member 163 such that a larger angle θ corresponds to a steeper slope of tapered member 163. The slope of tapered member 163 and the pressure within nozzle 160 contribute to the centration force required to center optical fiber 20 within nozzle 160.

As used herein, “centration force” is the net force acting on a fiber to center the fiber along a centerline, such as centerline CL of nozzle 160. The net force acting on a fiber is a result of the pressure distribution on the fiber. For example, if a fiber is offset from centerline CL when disposed within nozzle 160 such that the fiber is closer to a top surface of the nozzle than a bottom surface of the nozzle, the pressure distribution at the top of the fiber is not equal to the pressure distribution at the bottom of the fiber. More specifically, the gas or fluid surrounding the fiber (e.g., molten metal 30) would have a higher pressure at the top of the fiber than at the bottom of the fiber. The centration force is the force acting on the fiber to counteract any uneven pressure distribution acting on the fiber. A nozzle with a relatively higher centration force is advantageous as it provides a higher force acting on the fiber to center the fiber. Conversely, a nozzle with a relatively lower centration force provides a lower force acting on the fiber, so that the fiber is more prone to move to one side or another.

When optical fiber 20 is drawn from preform 10, upstream forces (for example, turbulent gas flow within pressure device 120) can cause the drawn optical fiber to move off-center from centerline CL. The drawn optical fiber 20 may be biased to one side of the centerline due to such upstream forces, causing an uneven net centration force. Additionally, downstream forces (for example, a downstream winder pulling the fiber to one side or another that is off-center from centerline CL) can cause the drawn optical fiber to move off-center from centerline CL. An even net pressure distribution is desirable so that the optical fiber 20 does not contact inner walls of nozzle 160. Any contact between optical fiber 20 and the walls of aperture 162 can cause deformities in the drawn optical fiber, which increase the Rayleigh scattering and attenuation in the drawn optical fiber. As optical fiber 20 moves through nozzle 160, the net pressure distribution acting on optical fiber 20 should ideally be even so that pressure applied to optical fiber 20 is even from all sides of the fiber.

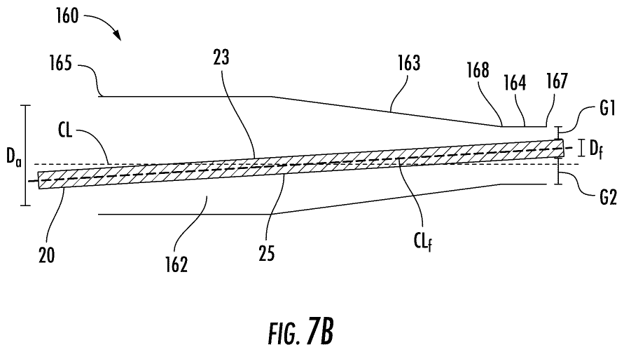

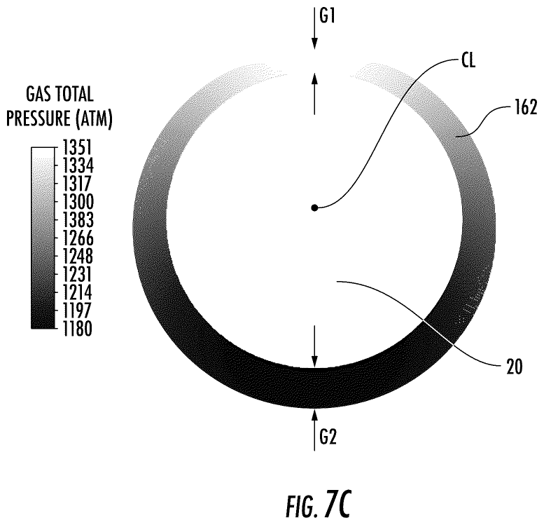

The magnitude of the centration force acting on fiber 20 is measured using equation (1) below:

$${F}_{x} = T sin {θ}_{c} \qquad ( 1 )$$

where Fₓ is the horizontal centration force acting on the fiber (grams-force), T is the tension force on the fiber (grams-force), and θ_{c} is the angle between a centerline CL_{f} of the fiber downstream of pressure device 120 and centerline CL of nozzle 160. As shown in FIG. 7A, angle θ_{c} is non-zero when the fiber is off-center from centerline CL. In one example, if optical fiber 20 is subjected to a pulling tension T of 100 grams-force and angle θ_{c} is 5 degrees, the centration force Fₓ required to maintain centerline CL_{f} of optical fiber 20 aligned with centerline CL of nozzle 160 is about 8.7 grams-force. In this example, a centration force Fₓ below about 8.7 grams-force will allow the fiber to be off-center from centerline CL of nozzle 160 (which is undesirable). It is desirable to have angle θ_{c} be as low as possible so that the centration force required to center the fiber is also reduced.

In the embodiments disclosed herein, the structure of nozzle 160 allows gas and/or fluid to flow through the nozzle while providing the necessary centration force so that centerline CF_{f} of optical fiber 20 remains aligned with centerline CL of nozzle 160. For example, the slope of tapered member 163 and the pressure within nozzle 160 contribute to the centration force produced by nozzle 160.

FIG. 6 shows an embodiment in which the centerline of optical fiber 20 is aligned with centerline CL of nozzle 160. As shown in FIG. 6, an outer diameter D_{f} of optical fiber 20 is less than an inner minimum diameter Dₐ of aperture 162 so that a gap is formed between optical fiber 20 and nozzle 160. At second end 167 of nozzle 160, the gap comprises a first gap G1 between the outer diameter of optical fiber 20 and an inner diameter of aperture 20 at a top surface 23 of optical fiber 20. Furthermore, at second end 167 of nozzle 160, the gap comprises a second gap G2 between the outer diameter of optical fiber 20 and an inner diameter of aperture 162 at a bottom surface 25 of optical fiber 20. Preferably, optical fiber 20 is radially centered about centerline CL of nozzle 160 so that first gap G1 is equal to (or approximately equal to) second gap G2, which occurs when the centration force is sufficiently high to center the optical fiber.

In embodiments, gaps G1 and G2 are each about 2 microns to about 20 microns, or about 4 microns to about 18 microns, or about 6 microns to about 16 microns, or about 8microns to about 14 microns, or about 10 microns to about 12 microns in length. However, the length of gaps G1 and G2 depends on the diameter of optical fiber 20. As discussed above, the length of gaps G1 and G2 may be the same or different from each. In some exemplary embodiments, gaps G1 and G2 are both about 8 microns in length or about 10 microns in length or about 12 microns in length. Furthermore, in embodiments a difference between the length of first gap G1 and the length of second gap G2 is only about 10% or less, or about 5% or less, or about 2.5% or less, or about 2% or less or about 1.5% or less, or about 1.25% or less, or about 1% or less, or about 0.75% or less, or about 0.5% or less, or about 0.25% or less, or about 0.1% or less of the length of either gap G1 or G2.

In the embodiment of FIG. 6, optical fiber 20 has an outer diameter D_{f} of about 125 microns. However, optical fiber 20 may comprise other outer diameters as are well known in the art. The inner minimum diameter of aperture Dₐ may be from about 130 microns to about 165 microns, or about 135 microns to about 160 microns, or about 140 microns to about 155 microns, or about 145 microns to about 150 microns. However, it is noted that the inner minimum diameter Dₐ of aperture 162 depends on the outer diameter D_{f} of optical fiber 20, such that a larger nozzle 160 with a relatively larger aperture diameter Dₐ may be required for relatively larger optical fibers. In some exemplary embodiments, optical fiber 20 has an outer diameter D_{f} of about 125 microns and aperture 162 has an inner minimum diameter Dₐ of about 145 microns. The inner minimum diameter Dₐ of aperture 162 is preferably close to the outer diameter D_{f} of optical fiber 20 (but not the same as) to effectively seal inner cavity 115 and to reduce/prevent flow of molten metal 30 out of nozzle 160 while still allowing clearance between optical fiber 20 and aperture 162 so that optical fiber 20 does not contact the inner walls of nozzle 160.

Nozzle 160 has a longitudinal length L (from first end 165 to second end 167 and along the centerline CL_{f} of the fiber) of about 0.05 mm or greater, or about 0.10 mm or greater, or about 0.15 mm or greater, or about 0.20 mm or greater, or about 0.22 mm or greater, or about 0.25 mm or greater. Additionally or alternatively, the length L of nozzle 160 is about 0.25 mm or less, or about 0.22 mm or less, or about 0.20 mm or less, or about 0.15 mm or less or about 0.10 mm or less, or about 0.05 mm or less. In some embodiments, the length L is from about 0.05 mm to about 0.25 mm, or about 0.10 mm to about 0.22 mm, or about 0.15 mm to about 0.20 mm. The length L should be sufficiently long to allow flow speed reduction of the process gas flowing from inner cavity 115 without inducing turbulence in the gas flow.

In embodiments, tapered member 163 has a longitudinal length (along the centerline CL_{f} of the fiber) from about 0.05 mm to about 0.25 mm, or about 0.10 mm to about 0.22 mm, or about 0.14 mm to about 0.20 mm, or about 0.14 mm to about 0.18 mm. Furthermore, in embodiments, cylindrical member 163 has a length from about 0.020 mm to about 0.100 mm, or about 0.040 mm to about 0.080 mm, or about 0.050 mm to about 0.070 mm, or about 0.055 mm to about 0.065 mm. Tapered member 163 of nozzle 160 may have the same maximum outer profile as inner cavity 115 and may directly connect with inner cavity 115. Thus, aperture 162 and inner cavity 115 may form a continuous opening through the draw furnace.

FIG. 7B (also not drawn to scale) depicts an image of when the centerline CL_{f} of optical fiber 20 is not centered with centerline CL of nozzle 160, such as when the centration force is not sufficient to center the fiber. Therefore, optical fiber 20 is radially offset from centerline CL of nozzle 160. In this example, first gap G1 is less than second gap G2. More specifically, in one exemplary example, first gap G1 is 6 microns, second gap G2 is 14 microns, aperture 162 has an inner minimum diameter Dₐ of 145 microns, and optical fiber 20 has an outer diameter D_{f} of 125 microns. Furthermore, in this exemplary example, optical fiber 20 traverses through nozzle 160 at a speed of 50 m/s and the length of tapered member 163 (along the centerline CL_{f} of the fiber) is 0.145 mm. Due to the different lengths of first and second gaps G1 and G2, the pressure of the gas flowing through first gap G1 is not equal to the pressure of the gas flowing through second gap G2. Therefore, the net centration force surrounding optical fiber 20 is not even, and optical fiber 20 is not centered about centerline CL of nozzle 160.

FIG. 7C shows the gas pressure at second end 167 of aperture 162 through gaps G1 and G2 of this exemplary example (where G1 is 6 microns in length and G2 is 14 microns in length). FIG. 7C is a cross-sectional view of gaps G1 and G2 at second end 167 of nozzle 162. First gap G1 is smaller than second gap G2 and, therefore, has a higher pressure therethrough. As shown in FIG. 7C, the pressure through first gap G1 is about 1350 atm while the pressure through second gap G2 is only about 1180 atm. Due to this difference in pressure between gaps G1 and G2, optical fiber 20 is not centered within nozzle 160 about centerline CL. Therefore, the net centration force is not even in FIG. 7C.

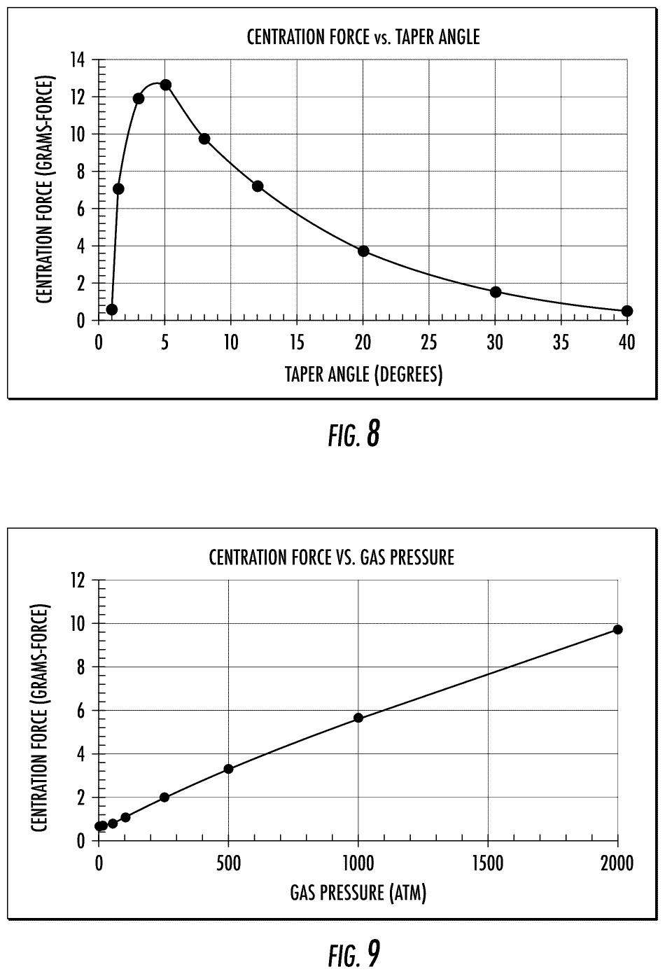

As noted above, the slope of tapered member 163 (i.e., the value of taper angle θ) and the total pressure within nozzle 160 determine the centration force provided by nozzle 160 to center optical fiber 20. FIG. 8 shows the relationship between centration force of nozzle 160 and the taper angle θ of tapered member 163 (using the exemplary nozzle embodiment of FIG. 6). In order to determine the relationship as depicted in FIG. 8, the pressure within inner cavity 115 was at an operating pressure of 2000 atm. As shown in FIG. 8, a taper angle θ of 5° produced the highest centration force. However, broader ranges were also shown to produce nozzles with sufficiently high centration force to properly center an optical fiber within the nozzle (so that the fiber does not contact the sides of the nozzle). In the embodiments disclosed herein, a taper angle θ between about 1.5 degrees and about 35 degrees produced a nozzle 160 with a sufficiently high centration force so that the nozzle was able to maintain optical fiber 20 centered about centerline CL. In embodiments, the taper angle θ is between about 2 degrees and about 30 degrees, or about 3 degrees and about 25 degrees, or about 4 degrees and about 20 degrees, or about 5 degrees and about 15 degrees, or about 5 degrees and about 10 degrees, or about 3 degrees and about 10 degrees, or about 4 degrees and about 7 degrees.

In the embodiments disclosed herein, the centration force of nozzle 160 is about 2 grams-force or greater, or about 5 grams-force or greater, or about 18 grams-force or greater, or about 10 grams-force or greater, or about 12 grams-force or greater in order to center optical fiber 20 about centerline CL.

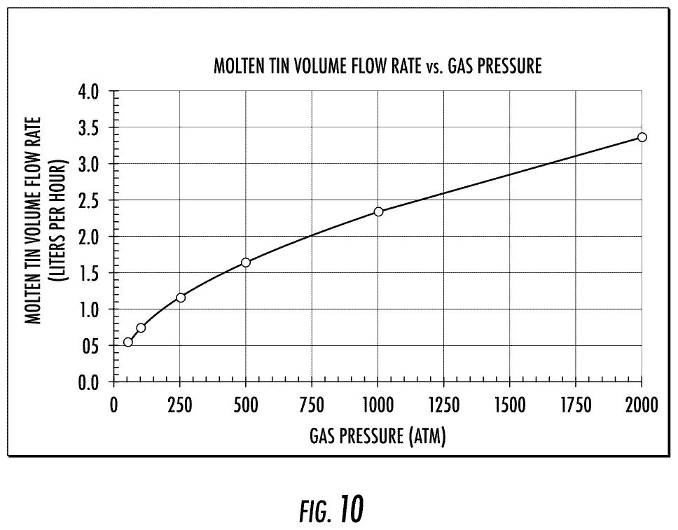

FIG. 9 shows the relationship between the centration force of nozzle 160 and the total gas pressure within inner cavity 115 (using the exemplary nozzle embodiment of FIG. 6). In order to determine this relationship as depicted in FIG. 9, the taper angle θ of tapered member 163 was 8°. As shown in FIG. 9, as the total gas pressure within the draw furnace increased, the centration force also increased. Therefore, a higher gas pressure corresponds to a higher centration force.

FIG. 10 shows the relationship between the flow rate of molten metal 30 within nozzle 160 and the total gas pressure within inner cavity 115 (using the exemplary nozzle embodiment of FIG. 6). In particular, FIG. 10 shows the relationship between the flow rate of molten tin within nozzle 160 and the total gas pressure within inner cavity 115. As shown in FIG. 10, as the gas pressure increases, the flow rate of the molten tin increases. Therefore, higher gas pressures correspond to a higher flow rate of molten metal 30. As discussed above with reference to FIG. 9, higher gas pressures also correspond to higher centration forces.

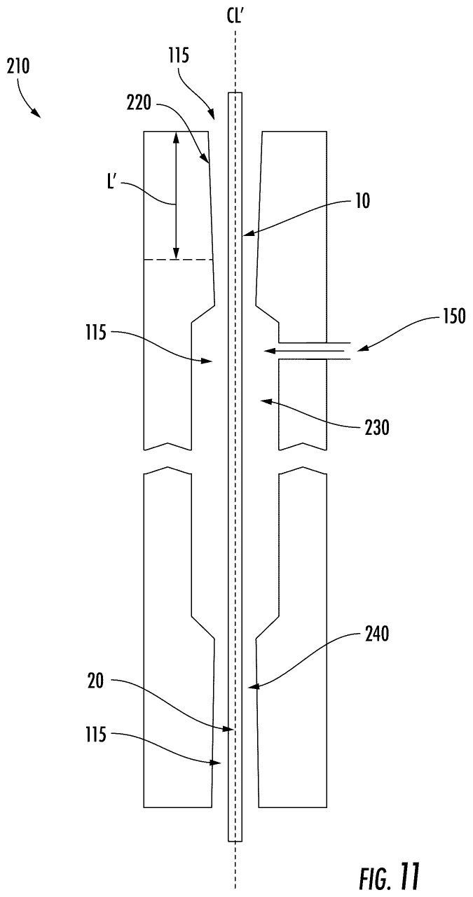

With reference again to FIG. 1, sleeve 110 of pressure device 120 may comprise straight and uniform inner walls or inner walls that vary in diameter. FIG. 11 shows another embodiment of a sleeve 210 of pressure device 120 that may be used in draw furnace 100. In the embodiment of FIG. 11, sleeve 210 comprises inner walls that vary in diameter. More specifically, in embodiments, sleeve 210 comprises an angled inlet region 220 with inner walls having a low-angle taper (e.g., about 0.5° to about 2° with reference to a centerline CL′ of sleeve 210) to maintain a laminar flow condition for process gas passing in an upstream direction within inner cavity 115. Angled inlet region 220 also has a length L′ that reduces the flow speed of process gas to a degree sufficient to avoid turbulence in the vicinity of preform 10. The laminar flow conditions and avoidance of turbulence within sleeve 210 minimize vibrations of preform 10, which helps to prevent physical contact between preform 10 and inner walls of pressure device 120.

Sleeve 210 further comprises chamber 230 which comprises a larger inner diameter than that of angled inlet region 220. As shown in FIG. 11, preform 10 is heated to a temperature above the softening point of the glass within chamber 230 to draw preform 10 into optical fiber 20. As discussed above, preform 10 may be heated to the temperatures disclosed above with reference to regions A and B while preform 10 is positioned within chamber 230. The diameter of chamber 230 transitions into angled outlet region 240, which has a smaller inner diameter than that of chamber 230. Angled outlet region 240 may have the same taper angle and length L′ as disclosed above with reference to angled inlet region 220. In embodiments, the length L′ of both angled inlet region 220 and angled outlet region 240 is in a range from about 100 mm to about 300 mm, or about 150 mm to about 250 mm, or about 200 mm.

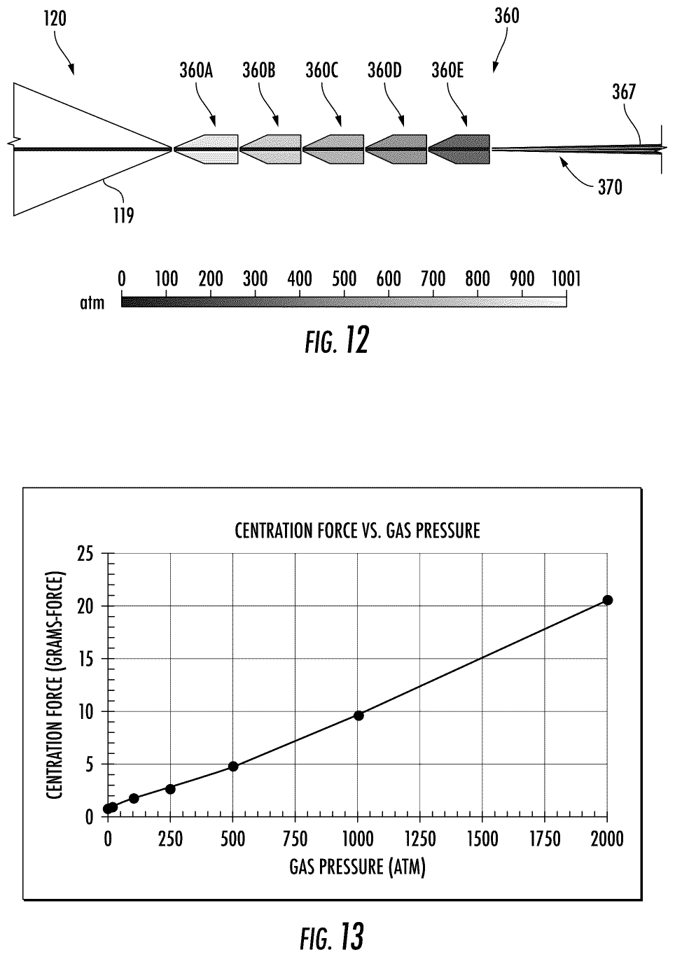

In the embodiments of FIGS. 1-3D and 6-7C, nozzle 160 is depicted as a single, unitary member. However, rather than one member, nozzle 160 may comprise a series of nozzles. FIG. 12 shows an embodiment in which nozzle 360 comprises a series of sub-nozzles 360A-360E and a tapered exit 370 at second end 367 of nozzle 360. Optical fiber 20 exits pressure device 120 at tapered exit 370, and tapered exit 370 leads to ambient pressure outside (downstream) of pressure device 120. Each sub-nozzle 360A-360E provides a centering force and the series of sub-nozzles act collectively to control the reduction in pressure from the relatively high pressure in pressure device 120 to the atmospheric pressure (downstream of tapered exit 370). FIG. 12 also illustrates in grayscale the static pressure within the sub-nozzles 360A-360E of nozzle 360 in an embodiment in which the pressure within the pressure device 120 is 1000 atm. As shown in FIG. 12, sub-nozzle 360A (positioned further from second end 367) has a relatively higher pressure than sub-nozzle 360E (positioned closest to second end 367).

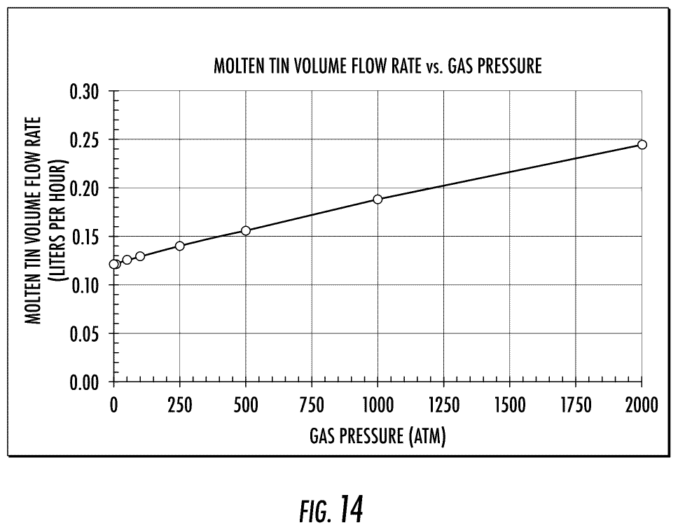

The relationship between centration force vs. total gas pressure within inner cavity 115 with the series of sub-nozzles embodiment of FIG. 12 is shown in FIG. 13. In particular, the nozzle comprise ten sub-nozzles arranged in series and the optical fiber disposed within is offset by 4 microns (such that, for example, first gap G1 is larger than second gap G2 by 4 microns). As shown in FIG. 13, at an operating pressure of 2000 atm within inner cavity 115, the nozzle produces a centration force of about 20 grams-force. As another example, as shown in FIG. 13, at an operating pressure of 1000 atm within inner cavity 115, the nozzle produces a centration force of about 10 grams-force. In comparison with the embodiment of FIG. 9, an operating pressure of 2000 atm produced the centration force of about 10 grams-force. Therefore, a lower operating gas pressure is required in the embodiment of FIG. 13 to achieve the same centration force as that of FIG. 9. It is further noted that the centration force of the nozzle embodiment of FIG. 13 can be increased by adding more sub-nozzles.

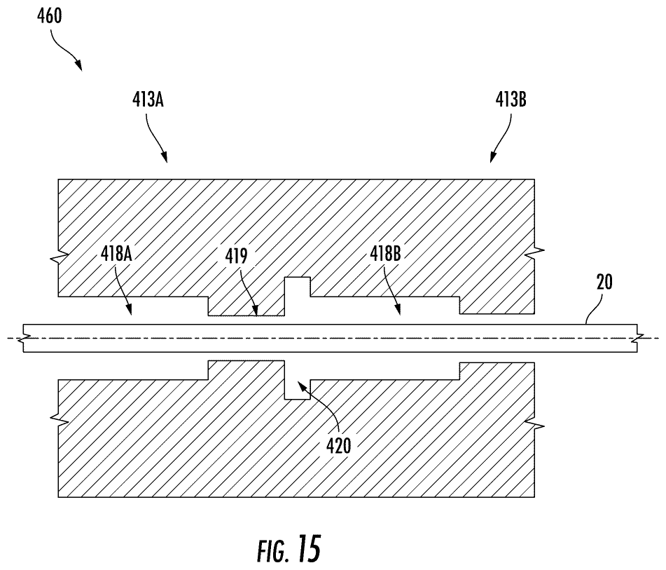

FIG. 14 shows the relationship between the flow rate of molten metal 30 vs. total gas pressure within inner cavity 115 with the series of sub-nozzles embodiment of FIG. 12. In particular, the nozzle comprise ten sub-nozzles arranged in series and the optical fiber disposed within is offset by 4 microns (such that, for example, first gap G1 is larger than second gap G2 by 4 microns). In particular, FIG. 14 shows the relationship between the flow rate of molten tin within the nozzle and the total gas pressure within inner cavity 115. As shown in FIG. 14, as the gas pressure increases, the flow rate of the molten tin increases. Therefore, higher gas pressures correspond to higher flow rate of molten metal 30. As discussed above with reference to FIG. 13, higher gas pressures also correspond to higher centration forces.

Other configurations for nozzle 160 are contemplated within the scope of the present disclosure. FIG. 15 shows an embodiment of a nozzle 460 that comprises a pair of step bearings 413A, 413B. Step bearing 413A forms an inner cavity 418A and step bearing 143B forms an inner cavity 418B, which are separated by step 419. Furthermore, groove 420 is provided between step bearing 413A and step bearing 413B to accept a seal (e.g., an O-ring). Although FIG. 15 shows two step bearings, it is contemplated that the nozzles disclosed herein may comprise more or less step bearings.

It should now be understood that the pressure devices and methods described herein enable the ability to make optical fibers with higher glass density due to compression of the optical fiber at or near the neckdown region of the preform as well as lower attenuation due to lower Rayleigh scattering coefficient. While not wishing to be bound by theory, the pressure provided by pressure device 120 on preform 10 is thought to decrease structural voids within the optical fiber drawn therefrom. The application of pressure to the optical fiber preform, as disclosed herein, leads to reductions in the Rayleigh scattering and overall attenuation in the drawn optical fiber compared to traditional drawing methods. As non-limiting examples, the pressure devices and methods described herein enable the production of optical fibers wherein the fiber attenuation is less than 0.175 dB/km at 1550 nm, less than 0.165 dB/km at 1550 nm, less than 0.155 dB/km at 1550, or less than 0.145 dB/km at 1550 nm. As further non-limiting examples, the pressure devices and methods described herein enable the production of optical fibers wherein the fiber attenuation is less than 0.31 dB/km at 1310 nm, less than 0.29 dB/km at 1310 nm, less than 0.27 dB/km at 1310, or less than 0.25 dB/km at 1310 nm. As further non-limiting examples, the pressure devices and methods described herein enable the production of optical fibers having a Rayleigh scattering coefficient of less than 0.87 dB/km/micron⁴, less than 0.82 dB/km/micron⁴, less than 0.77 dB/km/micron⁴, or less than 0.72 dB/km/micron⁴. As further non-limiting examples, the pressure devices and methods described herein enable the production of optical fibers having a Rayleigh scattering coefficient reduction of greater than 4%, greater than 8%, greater than 12%, or greater than 16% compared to an optical fiber drawn under identical conditions but without application of pressure by a pressure device.

For the purposes of describing and defining the embodiments of the present disclosure, it is noted that the terms “about,” “approximately,” and “substantially” are utilized herein to represent the inherent degree of uncertainty that may be attributed to any quantitative comparison, value, measurement, or other representation. The terms “about,” “approximately,” and “substantially” are also utilized herein to represent the degree to which a quantitative representation may vary from a stated reference without resulting in a change in the basic function of the subject matter at issue.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

According to a first aspect of the present disclosure, a method of forming an optical fiber is disclosed, the method comprising heating a forming region of the optical fiber preform within a pressure device while exposing the forming region to a total pressure of about 500 atm or greater, directing the optical fiber preform in a downstream direction along a process pathway to form the optical fiber, and traversing the optical fiber through an aperture of a nozzle to maintain the total pressure of about 500 atm or greater within the pressure device.

According to a second aspect of the present disclosure, the first aspect wherein the total pressure is about 1000 atm or greater.

According to a third aspect of the present disclosure, the first aspect wherein the total pressure is from about 500 atm to about 2000 atm.

According to a fourth aspect of the present disclosure, the first aspect wherein the total pressure is from about 750 atm to about 1750 atm.

According to a fifth aspect of the present disclosure, the first aspect wherein the

forming region of the optical fiber preform is heated to a temperature at or above a softening temperature of the preform.

According to a sixth aspect of the present disclosure, the first aspect wherein the forming region of the optical fiber preform is heated to a temperature from about 1570° C. to about 2100°° C.

According to a seventh aspect of the present disclosure, the first aspect wherein the nozzle provides a centration force that centers the optical fiber about a centerline of the nozzle.

According to an eighth aspect of the present disclosure, the seventh aspect wherein the centration force is about 2 grams-force or greater.

According to a ninth aspect of the present disclosure, the eight aspect wherein the centration force is about 5 grams-force or greater.

According to a tenth aspect of the present disclosure, the first aspect further comprising heating a molten metal, the molten metal being disposed within the nozzle and radially outward of the optical fiber.

According to an eleventh aspect of the present disclosure, the tenth aspect wherein the molten metal is radially outward of the optical fiber preform.

According to a twelfth aspect of the present disclosure, the tenth aspect wherein a temperature of the molten metal within the nozzle is about 1670° C. or less.

According to a thirteenth aspect of the present disclosure, the twelfth aspect wherein the temperature of the molten metal within the nozzle is about 1000° C. or less.

According to a fourteenth aspect of the present disclosure, the thirteenth aspect wherein the temperature of the molten metal within the nozzle is about 400° C. or less.

According to a fifteenth aspect of the present disclosure, the fourteenth aspect wherein a viscosity of the molten metal within the nozzle is from about 0.70 MPa·s to about 0.80 MPa·s.

According to a sixteenth aspect of the present disclosure, the first aspect wherein the nozzle comprises a cylindrical member and a tapered member, the tapered member having a taper angle θ between about 1.5 degrees and about 35 degrees.

According to a seventeenth aspect of the present disclosure, the sixteenth aspect wherein the taper angle θ is between about 2 degrees and about 30 degrees.

According to an eighteenth aspect of the present disclosure, the seventeenth aspect wherein the taper angle θ is between about 5 degrees and about 15 degrees.

According to a nineteenth aspect of the present disclosure, the first aspect further comprising centering the optical fiber within the nozzle such that a first gap between an outer diameter of the optical fiber and an inner minimum diameter of the aperture at a top surface of the optical fiber is approximately equal to a second gap between the outer diameter of the optical fiber and the inner minimum diameter of the aperture at a bottom surface of the optical fiber.

According to a twentieth aspect of the present disclosure, the nineteenth aspect wherein the first gap and the second gap are each about 2 microns to about 20 microns in length.

According to a twenty-first aspect, the first aspect wherein the aperture of the nozzle comprises a stepped surface.

According to a twenty-second aspect of the present disclosure, a fiber draw furnace is disclosed comprising a pressure device, a heater, and a nozzle. The pressure device comprising an inner cavity configured to receive an optical fiber preform. The heater being configured to heat at least a forming region of an optical fiber preform to draw the optical fiber preform into an optical fiber, and the heater being configured to heat the forming region while exposing the optical fiber preform to a total pressure of about 500 atm or greater within the inner cavity. The nozzle being disposed downstream of the inner cavity and configured to maintain the total pressure of about 500 atm or greater within the inner cavity while the optical fiber traverses through an aperture in the nozzle.

According to a twenty-third aspect of the present disclosure, the twenty-second aspect further comprising a gas inlet configured to inject a process gas into the inner cavity, and wherein the total pressure of about 500 atm or greater is a total gas pressure.

According to a twenty-fourth aspect of the present disclosure, the twenty-second aspect wherein the nozzle comprises a cylindrical member and a tapered member, the tapered member having a taper angle θ between about 1.5 degrees and about 35 degrees.

According to a twenty-fifth aspect of the present disclosure, the twenty-fourth aspect wherein the taper angle θ is between about 2 degrees and about 30 degrees.

According to a twenty-sixth aspect of the present disclosure, the twenty-fifth aspect wherein the taper angle θ is between about 5 degrees and about 15 degrees.

According to a twenty-seventh aspect of the present disclosure, the twenty-second aspect wherein the nozzle comprises a cylindrical member and a tapered member, the cylindrical member being downstream of the tapered member.

According to a twenty-eighth aspect of the present disclosure, the twenty-second aspect wherein an inner minimum diameter of the nozzle is from about 130 microns to about 165 microns.

According to a twenty-ninth aspect of the present disclosure, the twenty-second aspect wherein the nozzle has a longitudinal length from about 0.05 mm to about 0.25 mm.

According to a thirtieth aspect of the present disclosure, the twenty-second aspect wherein the nozzle comprises a tapered member having a longitudinal length from about 0.10 mm to about 0.22 mm.

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A method of forming an optical fiber, the method comprising:
heating a forming region of the optical fiber preform within a pressure device while exposing the forming region to a total pressure of about 500 atm or greater;
directing the optical fiber preform in a downstream direction along a process pathway to form the optical fiber; and
traversing the optical fiber through an aperture of a nozzle to maintain the total pressure of about 500 atm or greater within the pressure device.

2. The method of claim 1, wherein the total pressure is about 1000 atm or greater.

3. The method of claim 1, wherein the total pressure is from about 500 atm to about 2000 atm.

4. The method of claim 3, wherein the total pressure is from about 750 atm to about 1750 atm.

5. The method of claim 1, wherein the forming region of the optical fiber preform is heated to a temperature at or above a softening temperature of the preform.

6. The method of claim 1, wherein the forming region of the optical fiber preform is heated to a temperature from about 1570° C. to about 2100° C.

7. The method of claim 1, wherein the nozzle provides a centration force that centers the optical fiber about a centerline of the nozzle.

8. The method of claim 7, wherein the centration force is about 2 grams-force or greater.

9. The method of claim 8, wherein the centration force is about 5 grams-force or greater.

10. The method of claim 1, further comprising heating a molten metal, the molten metal being disposed within the nozzle and radially outward of the optical fiber.

11. The method of claim 10, wherein the molten metal is radially outward of the optical fiber preform.

12. The method of claim 10, wherein a temperature of the molten metal within the nozzle is about 1670° C. or less.

13. The method of claim 12, wherein the temperature of the molten metal within the nozzle is about 1000° C. or less.

14. The method of claim 13, wherein the temperature of the molten metal within the nozzle is about 400° C. or less.

15. The method of claim 14, wherein a viscosity of the molten metal within the nozzle is from about 0.70 MPa·s to about 0.80 MPa·s.

16. The method of claim 1, wherein the nozzle comprises a cylindrical member and a tapered member, the tapered member having a taper angle θ between about 1.5 degrees and about 35 degrees.

17. The method of claim 16, wherein the taper angle θ is between about 2 degrees and about 30 degrees.

18. The method of claim 1, further comprising centering the optical fiber within the nozzle such that a first gap between an outer diameter of the optical fiber and an inner minimum diameter of the aperture at a top surface of the optical fiber is approximately equal to a second gap between the outer diameter of the optical fiber and the inner minimum diameter of the aperture at a bottom surface of the optical fiber.

19. The method of claim 18, wherein the first gap and the second gap are each about 2 microns to about 20 microns in length.

20. The method of claim 1, wherein the aperture of the nozzle comprises a stepped surface.
